(19) United States
(12) Patent Application Publication
(10) Pub. No.: US 2002/0070260 A1
(43) Pub. Date: Jun. 13, 2002

(54) Combined welding tool

(76) Inventor: Michael Miglorino, Ashburnham, MA (US)

Correspondence Address: Brian M. Dingman, Esq., Mirick, O'Connell, DeMallie & Lougee, LLP, 1700 West Park Drive, Westborough, MA, 01581-3941, US

(21) Appl. No.: 10/011,083

(22) Filed: Dec. 7, 2001

Related U.S. Application Data
(60) Provisional application No. 60/254,029, filed on Dec. 8, 2000.

(51) Int. Cl. B23K 20/08

(52) U.S. Cl. 228/33

(57) ABSTRACT

A combined welders tool, comprising a tool body, a striker head with a striker surface on one side, and a file on the other side, and one or more tip cleaning tools coupled to the tool body.

### CROSS REFERENCE TO RELATED APPLICATION

This application claims priority of Provisional application No. 60/254,029, filed on Dec. 8, 2000.

### FIELD OF THE INVENTION

This invention relates to a welder's tool.

### BACKGROUND OF THE INVENTION

Metal fabricators and craftsmen use three distinct tools when doing torch work. A file is used to prepare the torch tip. Tip cleaners, which are thin, file-like rods of different diameters for different tips, are used to clear the torch tip holes in order to provide for proper gas flow. A striker is used to ignite the flame. Each of these three tools is essential, and must be within reach at all times. However, when a worker is in working position on a ladder, scaffolding, or even at a bench, it is a problem for the worker to keep track of all three tools and to keep them within reach.

### SUMMARY OF THE INVENTION

The invention comprises a combination of the file and tip cleaners into a striker tool. The result is that all three of these needed tools are always available in a single tool.

This invention features a combined welders tool, comprising: a tool body; a striker head with a striker surface on one side, and a file on the other side; and one or more tip cleaning tools coupled to the tool body. The tip cleaning tools are preferably pivotably coupled to the tool body to allow one or more tip cleaners to move into an operable position to be used to clean gas flow holes. The tool may further comprise means to retain the tip cleaners in place stowed against the tool. The means to retain the tip cleaners in place stowed against the tool may comprise a retaining sleeve. The retaining sleeve may be movable along the tool body.

### BRIEF DESCRIPTION OF THE DRAWINGS

Other objects, features and advantages will occur to those skilled in the art from the following description of the preferred embodiment, and the accompanying drawings, in which:

FIG. 1 is a front view of the preferred embodiment of the tool of this invention;

FIG. 2 is a rear view of the tool of FIG. 1; and

FIG. 3 is a side view of the tool of FIG. 1, with the tip cleaners extended for use.

### DESCRIPTION OF THE PREFERRED EMBODIMENT

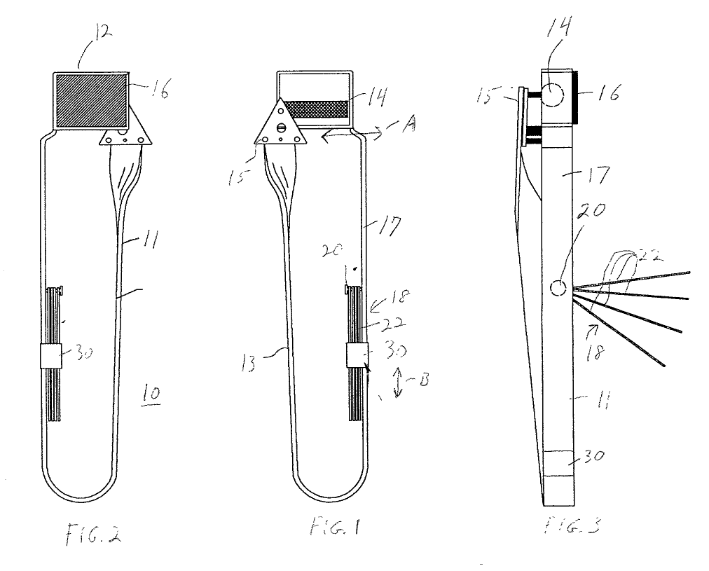

The preferred embodiment of the tool of the invention is shown in the three views in the attached drawings. A typical striker tool has arm 13 with movable striker portion 15 that is moved along surface 14 to create a spark. Tool 10 in this invention also carries fine cut file 16 on the opposite side of distal portion 12 from surface 14. File 16 is used to clean a torch tip surface. Tip cleaner assembly 18 is added in some fashion to the body 11 of tool 10. In the example shown, a stud or bolt 20 with a number of different-diameter, pivotably attached tip cleaning tools 22 is fixed to side portion 11 of welding tool 10. A retainer band 30 that fits over the tip cleaners 22 as well as portion 17 of tool body 11, is used to hold the tip cleaners aligned with body 11 when not in use. In order to use a tip cleaner, band 30 is slid down in the direction of arrow B, or removed as appropriate depending upon the design, and the proper size tip 22 is pivoted on member 20 as shown in side view FIG. 3. After use, the tip or tips are stowed back in the position shown in FIGS. 1 and 2.

Finally, the tool also provides the striker function with striker surface 14 and movable striker portion 15 that moves back and forth in the direction of arrow A to provide the spark.

The tool is used as follows. The tip surface is prepared with file 16. Retaining band 30 is then slid down, which frees the stainless steel tip cleaners 22. The proper tip size is selected and used to clean the gas flow holes. The tips are then returned to their starting position and the band then slid back over the tips to hold them in place so they do not interfere with the striker or file functions of the tool. The striker is then used in its normal fashion.

What is claimed is:

1. A combined welders tool, comprising:
a tool body;
a striker head with a striker surface on one side, and a file on the other side; and
one or more tip cleaning tools coupled to the tool body.

2. The tool of claim 1, wherein the tip cleaning tool are pivotably coupled to the tool body to allow one or more tip cleaners to move into an operable position to be used to clean gas flow holes.

3. The tool of claim 2, further comprising means to retain the tip cleaners in place stowed against the tool.

4. The tool of claim 3, wherein the means to retain the tip cleaners in place stowed against the tool comprises a retaining sleeve.

5. The tool of claim 4, wherein the retaining sleeve is movable along the tool body.

6. A combined welders tool, comprising:
a tool body;
a striker head with a striker surface on one side, and a file on the other side;
one or more tip cleaning tools pivotably coupled to the tool body to allow one or more tip cleaners to move into an operable position to be used to clean gas flow holes; and
a retaining sleeve movable along the tool body, to retain the tip cleaners in place stowed against the tool.
